(19) United States
(12) Patent Application Publication
(10) Pub. No.: US 2005/0122944 A1
(43) Pub. Date: Jun. 9, 2005

(54) Frame structure for selecting bridge device in high-speed wireless personal area network and method of selecting bridge device therein

(76) Inventors: Seo-Won Kwon, Seoul (KR); Se-Youn Lim, Seoul (KR); Jin-Hee Kim, Suwon-si (KR); Jae-Yeon Song, Seoul (KR); Yoon-Sun Lee, Seoul (KR); Jong-Hwa Lee, Suwon-si (KR)

Correspondence Address: CHA & REITER, LLC, 210 ROUTE 4 EAST STE 103, PARAMUS, NJ, 07652, US

(21) Appl. No.: 10/890,362

(22) Filed: Jul. 13, 2004

(30) Foreign Application Priority Data
Dec. 5, 2003 (KR) 2003-88049

(51) Int. Cl. H04Q 7/00; H04Q 7/24

(52) U.S. Cl. 370/338; 370/328

(57) ABSTRACT

A method and system is disclosed that can support communications among devices contained in different piconets in a high-speed Wireless Personal Area Network. The high-speed WPAN includes a parent piconet, a newly designated child piconet using time slots allocated among devices in the parent piconet, and a bridge device which is located in the child piconet, that broadcasts information about the devices of the parent piconet and the child piconet to the devices included in the high-speed WPAN, and operates to perform a data transfer between a device in the child piconet and a device in the parent piconet. A media access control (MAC) frame structure that includes an overall capability field for indicating an overall capability of a specific device, a length field for indicating a length of a frame, and an element identifier (ID) field for identifying respective elements is used by the bridge device to facilitate communications. The overall capability field includes a device capability field for indicating a capability of the specific device, a piconet coordinator capability field for indicating a capability for determining whether the specific device can be a piconet coordinator (PNC), and a bridge capability field for indicating a capability for determining whether the specific device can be the bridge device. Criteria for establishing the bridge device are also disclosed.

### CLAIM OF PRIORITY

This application claims, pursuant to 35 USC 119, priority to that patent application entitled “Frame Structure For Selecting Bridge Device In High-Speed Wireless Personal Area Network And Method Of Selecting Bridge Device Therein” filed in the Korean Intellectual Property Office on Dec. 5, 2003 and assigned Serial No. 2003-88049, the contents of which are hereby incorporated by reference.

### BACKGROUND OF THE INVENTION

1. Field of the Invention

The present invention relates to an IEEE 802.15.3 high-speed wireless personal area network (WPAN) using an ultra-wide band (UWB), and more particularly to a high-speed WPAN which can support communications among devices included in different piconets in the high-speed WPAN.

2. Description of the Related Art

A wireless communication technique using UWB is a technique that guarantees a transmission distance in the range of 10 m to 1 km. The UWB wireless communication technique had been used as a military wireless communication technique by the US Department of Defense for the past 40 years, and has been open to the nonmilitary sector by the Federal Communications Commission (FCC), which is the US authority on communication frequencies.

The UWB wireless communication technique is a ultrahigh-speed wireless data transmitting technique using a UWB of several GHz, and has the characteristics of a high transmitting speed (of 500 Mbps to 1 Gbps) and a low power consumption (1/100 of the power consumption of a mobile phone or a wireless LAN) in comparison to the existing IEEE 802.11, Bluetooth, etc. The UWB wireless communication technique can be used in diverse fields such as a short-distance personal communication network that connects a computer, peripheral devices and home appliances to an ultrahigh-speed wireless interface in a short distance, e.g. up to 100 m , a radar for examining, by fluoroscopy, the interior of a building, a high-precision position measurement, a device for preventing a car collision, an underground mine detector, a system for preventing the loss of an article, a detection of an object inside a body, etc.

A standard for the UWB wireless communication technique that has been proposed as a high-speed wireless personal area network (WPAN) is referred to as IEEE 802.15.3. In the standards of IEEE 802 groups, IEEE 802.15.1 is a group that establishes the Bluetooth standards, and IEEE 802.11 is a group that establishes the wireless LAN standards.

Bluetooth has been commercialized as a widely known personal area network (PAN), and has recently been applied to many network-related products. Bluetooth generally uses a frequency band of 2.4 GHz (i.e., ISM band), and provides a personal area network (PAN) solution with its communication distance limited to less than 10 m. The wireless LAN using IEEE 802.11 group protocol has already been standardized and uses the 2.4 GHz and the 5.0 GHz frequency bands.

IEEE 802.15.3 is further divided into TG1 (Task Group 1), TG2 and TG3. Here, TG1 is a group that establishes the Bluetooth standards, and TG2 is a group that makes a technical analysis of methods for enabling the Bluetooth products and the existing wireless LAN business to coexist. TG3 is a group that researches the standard of a high data rate PAN solution, and is now conducting research in a transmission system having a transmission speed of more than 55 Mbps. The present invention concerns the high data rate PAN solution according to TG3.

FIG. 1 is a view illustrating an example of a piconet designated among communication devices in an IEEE 802.15.3 high-speed wireless PAN. As shown, the piconet that designates the high-speed wireless PAN is composed of a plurality of communication devices 10, 12, 14, 16 and 18. One device 10 among them operates as a piconet coordinator (PNC). Here, the PNC serves as a master of the corresponding piconet and performs synchronization with the respective devices, manages time slots for data communication, and performs other control operations.

Specifically, the PNC device 10 manages the time slots required for the communications among the devices located in the piconet by using a message called a beacon in order to perform synchronization with the other connected devices 12, 14, 16 and 18. PNC 10 additionally serves to control a QoS (Quality of Signal), a power save mode, and piconet access.

As described above, the IEEE 802.15.3 device 10, which serves as the piconet coordinator, can designate a piconet as follows:
1. PNC device 10 searches channels in order to start the piconet, selects one of the channels which are not in use;
2 broadcasts a beacon frame through the selected channel; and
3. provides and allocates identifications for the respective devices, in this case, devices 12, 14, 16 and 18, which have received the broadcast beacon frame and set the channel for their communications in response to the received beacon frame.

In another aspect, a device, which has moved from the outside to the already designated piconet A, may request connection with another device in the piconet A designated by the PNC device 10. Accordingly, the PNC device 10, as controller, provides a single device ID, which can be used in the piconet A, to the device that has requested the connection.

Through the above-described process, the piconet as shown in FIG. 1 is designated. In this case, devices 12, 14, 16 and 18 make requests of PNC device 10 for data transmission. The PNC device 10 allocates communicable time slots to the respective devices 12, 14, 16 and 18 in response to the data transmission request from the respective devices 12, 14, 16 and 18. When the PNC device 10 allocates the time slots to the respective devices 12, 14, 16 and 18, it uses the beacon frame. The respective devices 12, 14, 16 and 18 perform the data transmission for a time corresponding to the time slot allocated by the PNC device 10.

Meanwhile, if a device desires to terminate the communication in the piconet or to perform a disconnection from the device, a piconet disassociation procedure is performed between the PNC device 10 and the corresponding device. Accordingly, the PNC device 10 deletes information about the recorded device through the piconet disassociation procedure.

The piconet designated between the PNC device 10 and the respective devices 12, 14, 16 and 18 may be divided into an independent piconet which can independently allocate the time slots to the devices existing in the piconet, and a dependent piconet which distributes and allocates the time slots provided from a PNC device located outside the piconet to the devices existing in the piconet. If a dependent piconet is newly produced in an independent piconet, the independent piconet is referred to as a parent piconet, and the newly produced dependent piconet is referred to as a child piconet or a neighbor piconet. That is, the independent piconet becomes the parent piconet, and the dependent piconet becomes the child piconet. In this case, the child piconet (i.e., dependent piconet) shares and uses the channel provided from the PNC device of the parent piconet.

FIG. 2 is a view illustrating an example of a dependent piconet designated in the IEEE 802.15.3 high-speed wireless PAN network. In this illustrative example, the existing piconet becomes a parent piconet 30, and a PNC device, for example device 32, of the parent piconet 30 is called a P-PNC device. Another device having the capability of being a PNC device, other than the already designated P-PNC device 32 among the devices 22, 32 and 42, which constitute the parent piconet 30, can be designated a child piconet 20. In this case, device 22 is selected to be the child PCN (C-PCN)

In this case, the P-PNC device 32, which is located in the parent piconet 30, allocates time slots to the C-PCN device 22 and another device 34, that is shown herein representative of the child piconet, and transmits the beacon frame. Here, the C-PNC device 22 is a device that performs a PNC function in the child piconet 20.

C-PNC device 22 may also designate the child piconet 20, and separately manage and control the device 24 that designates the child piconet 20. The communication in the child piconet 20 can be performed only between the devices 22 and 24 that designate the child piconet 20.

Accordingly, the C-PNC device 22 is a member of parent piconet 30, while also managing and controlling the child piconet 20. Thus, the C-PNC device 22 can perform a communication with the devices 32 and 34 in the parent piconet 30.

FIG. 3 is a view illustrating a conventional WPAN composed of a parent piconet and a child piconet. In this illustrative example, a P-PNC device 62 manages a C-PNC device 42 and a device G 64 which are members of a parent piconet 60. Also, the C-PNC device 42 manages a device A 47 and a device B 49 as members of a child piconet 40.

The P-PNC device 62 generates mapping information composed of MAC (Media Access Control) addresses of 64 bits and device IDs of 8 bits using information transmitted from the devices 42 and 64, and stores and manages the mapping information in a P-MIB (Parent Piconet Management Information Base) 63. Also, the P-PNC device 62 broadcasts information about the devices 42 and 64 registered in the parent piconet 60 using a beacon frame. Only the devices 42, 62 and 64 registered in the parent piconet 60 can receive the beacon frame broadcast by the P-PNC device 501. The respective devices 42 and 64 in the parent piconet 60 generate mapping information about the devices 42 and 64 using information of the beacon frame transmitted from the P-PNC device 62, store and manage the mapping information in P-MIBs 44 and 65 of the respective devices.

In the case of transmitting data to the P-PNC device 62, the device G 64 searches for the mapping information from the P-MIB 65, and transmits the data with reference to the device ID of the P-PNC device 62.

Meanwhile, the C-PNC device 42 that manages and controls the child piconet 40 broadcasts information about the device A 47 and the device B 49 that exist in the child piconet 40, which are not registered as mapping information of a C-MIB (Child Piconet Management Information Base) 43, using the beacon frame. Here, only the devices 46 and 48, which are registered as the child piconet 40 in the C-PNC device 42, can receive the beacon frame.

Device A 46 and device B 48 also store and manage the mapping information about the devices registered in the C-MIB 43 of the C-PNC device 42 in the C-MIBs 47 and 49 using the beacon frame information broadcast from the C-PNC device 42. Accordingly, in the case of transmitting data to the device B 48, the device A 46 searches for the mapping information stored in the C-MIB 47, and transmits the data with reference to the device ID information of the device B 48.

As described above, the current IEEE 802.15.3 standard does not consider such communications between devices located in different piconets, but defines only a PNC device and a general device. Hence, there is a need in the industry to enable communications between piconets that will extend the range of UWB devices.

### SUMMARY OF THE INVENTION

Accordingly, the present invention has been made to solve the above-mentioned problems occurring in the prior art, and an object of the present invention is to provide a bridge device, and bridge device selecting method that is required for communications between different piconets, a new frame structure for selecting a bridge device, and new information elements thereof in a IEEE 802.15.3 high-speed wireless personal area network (WPAN) using a UWB (Ultra-Wide Band).

In order to accomplish this object, there is provided a frame structure for selecting a bridge device in a high-speed wireless personal area network (WPAN) which includes a parent piconet designated in advance and having a plurality of devices, a newly designated child piconet using time slots allocated from the devices located in the parent piconet, and a bridge device which is located in the child piconet, that broadcasts information about the devices of the parent piconet and information about the devices of the child piconet to the devices included in the high-speed WPAN, and operates to perform a data transfer between a first specific device included in the child piconet and a second specific device included in the parent piconet, the frame structure providing a media access control (MAC) frame which includes an overall capability field, composed of 9 bytes, for indicating an overall capability of a specific device, a length field, composed of one byte, for indicating a length of a frame, and an element identifier (ID) field for identifying respective elements, wherein the overall capability field includes a device capability field for indicating a capability of the specific device, a piconet coordinator capability field for indicating a capability for determining whether the specific device can be a piconet coordinator (PNC), and a bridge capability field for indicating a capability for determining whether the specific device can be the bridge device.

In another aspect of the present invention, there is provided a method of selecting a bridge device in a high-speed wireless personal area network (WPAN) which includes a parent piconet designated in advance and having a plurality of devices, a newly designated child piconet using time slots allocated from the devices located in the parent piconet, and a bridge device which is located in the child piconet, that broadcasts information about the devices of the parent piconet and information about the devices of the child piconet to the devices included in the high-speed WPAN, and operates to perform a data transfer between a first specific device included in the child piconet and a second specific device included in the parent piconet, the method comprising a first step of detecting devices which can operate as the bridge device, a second step of selecting the corresponding device as the bridge device if one device which can operate as the bridge device is detected, while comparing sizes of buffers of the detected devices, which have physically been determined, if plural devices which can operate as the bridge device are detected, a third step of selecting the device having the largest buffer size as a result of comparison at the second step as the bridge device, and if there are plural devices having the same largest buffer size, selecting a piconet coordinator among the devices having the same largest buffer size as the bridge device, a fourth step of selecting the device whose security bit is activated as the bridge device if there is no piconet coordinator among the devices having the same largest buffer size, a fifth step of selecting the device having a power source as the bridge device if there are plural devices whose security bits are activated, or if there is no device whose security bit is activated at the fourth step, a sixth step of selecting the device having a large number of associated devices as the bridge device if there are plural devices having the power source, or if there is no devices having the power source at the fifth step, a seventh step of selecting the device having a large output power if there are plural devices having a large number of associated devices at the sixth step, and an eighth step of selecting the device having a high transmission speed as the bridge device if there are plural devices having the large output power, or if there is no device having the large output power at the seventh step.

### BRIEF DESCRIPTION OF THE DRAWINGS

The above features and advantages of the present invention will be more apparent from the following detailed description taken in conjunction with the accompanying drawings, in which:

FIG. 1 is a view illustrating an example of a piconet designated among devices in an IEEE 802.15.3 high-speed wireless personal area network;

FIG. 2 is a view illustrating an example of a dependent piconet designated in an IEEE 802.15.3 high-speed wireless personal area network;

FIG. 3 is a view illustrating a conventional WPAN composed of a parent piconet and a child piconet;

FIG. 4 is a view illustrating a high-speed WPAN system having a bridge device according to an embodiment of the present invention;

FIG. 5 is a view illustrating a conventional capability field structure of a device of a MAC frame according to the IEEE 802.15.3;

FIG. 6 is a view illustrating a capability field structure of a device of a MAC frame according to the present invention;

FIG. 7 is a view illustrating an example of a bridge group information element that is added to a MAC frame in which a bridge (BRG) capability field is included according to the present invention;

FIG. 8 is a view illustrating another example of a bridge group information element that is added to a MAC frame in which a bridge (BRG) capability field is included according to the present invention;

FIG. 9 is a view illustrating an example of a bridge shutdown information element that is added to a MAC frame in which a bridge (BRG) capability field is included according to the present invention; and

FIG. 10 is a view illustrating an example of a bridge device change information element that is added to a MAC frame in which a bridge (BRG) capability field is included according to the present invention.

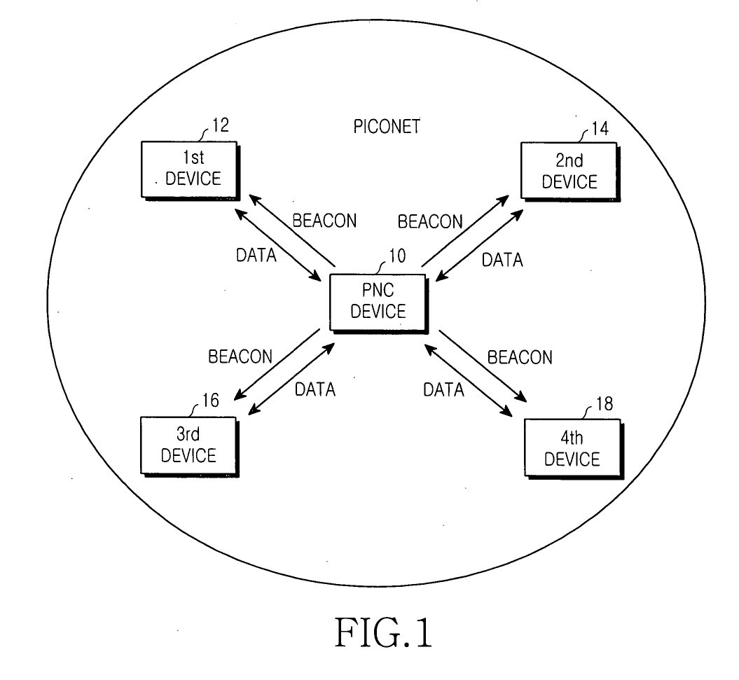

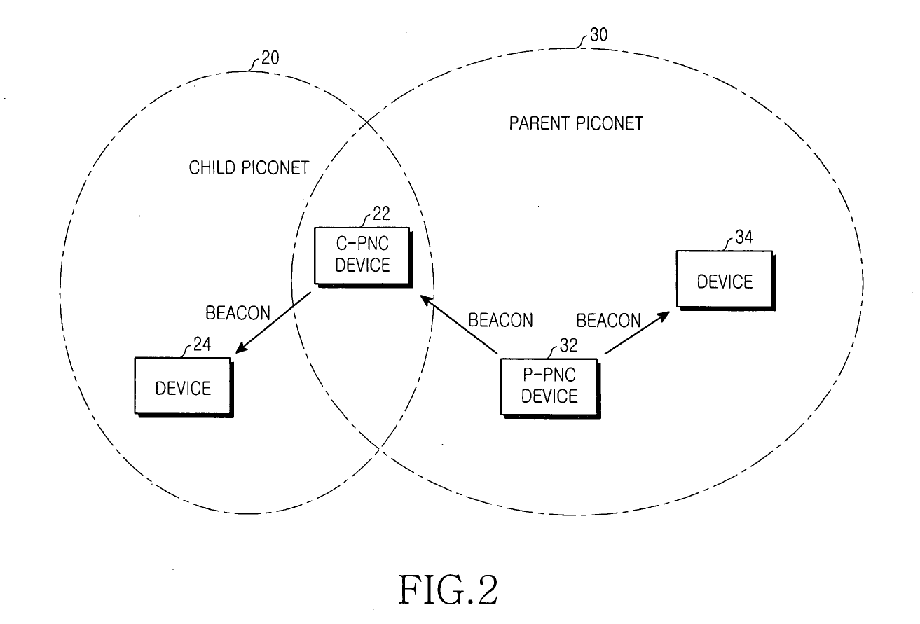

### DETAILED DESCRIPTION OF THE INVENTION

Hereinafter, a frame structure for selecting bridge device in high-speed wireless personal area network (WPAN) and a method of selecting bridge device therein according to embodiments of the present invention will be described with reference to the accompanying drawings. In the following description of the present invention, same drawing reference numerals are used for the same elements even in different drawings. For purposes of clarity, a detailed description of known functions and configurations incorporated herein will be omitted when it may make the subject matter of the present invention unclear.

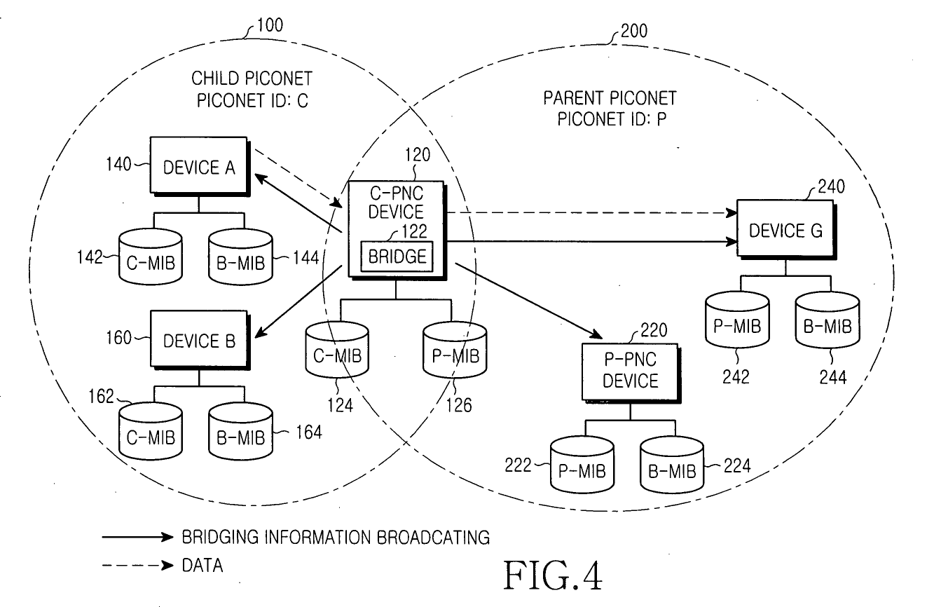

FIG. 4 is a view illustrating a high-speed WPAN system having a bridge device according to an embodiment of the present invention. As shown, the high-speed WPAN system according to the present invention is composed of a device having a bridging function and other devices.

The device having the bridging function broadcasts information about the devices which are located in different piconets to the devices which exist in the different piconets. Here, the information about the devices which exist in the different piconets is called bridging information. If the respective devices receive the information about the devices which exist in the different piconets, they generate B-MIBs (Bridging Management Information Bases) of the devices through the received information about the devices. Meanwhile, the device having the bridging function switches the data transmitted from the devices located in the different piconets.

In the present invention, the device having the bridging function is set as a C-PNC device 120. Accordingly, the C-PNC device 120 has a bridge 122 for switching data transmitted from the different piconets.

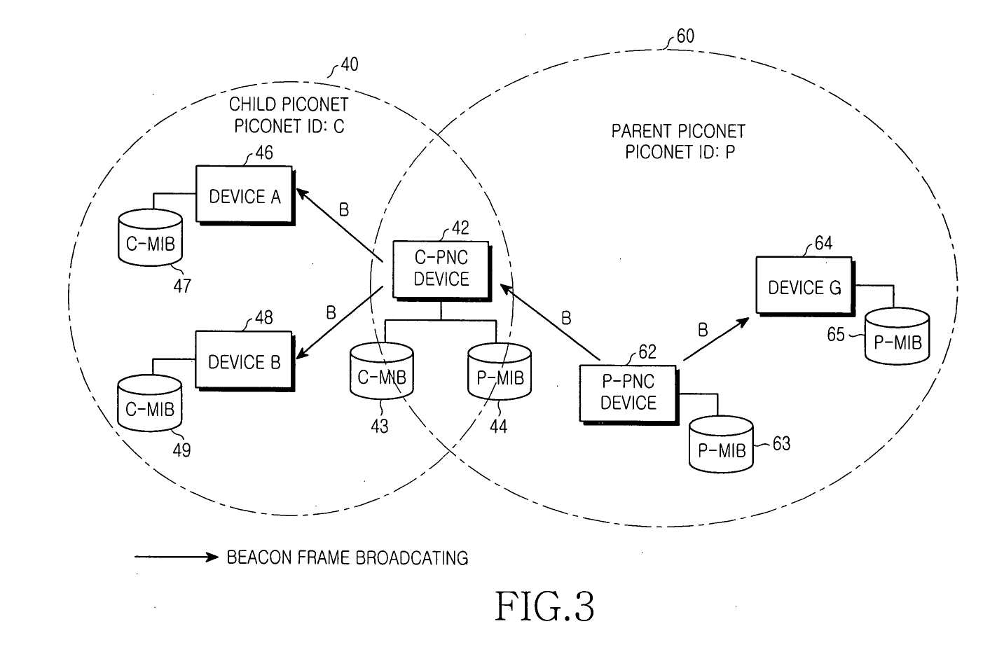

The high-speed WPAN as illustrated in FIG. 4 forms different piconets which are a parent piconet 200 and a child piconet 100. Here, the piconet ID of the parent piconet 200 is designated with the letter ‘P’, and the piconet ID of the child piconet 100 is designated with the letter ‘C’. In this case, it is assumed that information about addresses and IDs of the devices which are located in the parent piconet 200 and the child piconet 100 is the same as the information as illustrated in FIG. 3.

A P-PNC device 220 manages a C-PNC device 120 having a bridging function and a device G 240, which are members of the parent piconet 200. Also, the C-PNC device 120 manages ad evice A 140 and a device B 160 as members of the child piconet 100.

The P-PNC device 220 generates and manages P-MIB (Parent Piconet Management Information Base) mapping information which includes MAC (Media Access Control) addresses of 64 bits and device IDs of 8 bits using information transmitted from the devices 120 and 240 located in the parent piconet 200. Also, the P-PNC device 220 broadcasts information about the devices 120 and 240 registered as the parent piconet 200 in a P-MIB 222. The C-PNC device 120 and the device G 240 generate mapping information using information of the beacon frame broadcast from the P-PNC device 220, and store the mapping information in the P-MIBs 126 and 242.

Accordingly, the devices 220, 120 and 240 located in the parent piconet 200 communicate with one another using the mapping information stored in the shared P-MIBs 222, 126 and 242.

The C -PNC device 120 broadcasts information about the device A 140 and the device B 160 which exist in the child piconet 100, which are registered in a C-MIB (Child Piconet Management Information Base) 124, using the beacon frame. The device A 140 and the device B 160 construct and manage C-MIBs 142 and 162 of the devices which are located in the child piconet 100 using the beacon frame information broadcast from the C-PNC device 120.

Accordingly, the devices 120, 140 and 160 located in the child piconet 100 communicate with one another using the shared C-MIBs 124, 142 and 162.

Meanwhile, the C-PNC device 120 that is the device having the bridging function has access to both the C-MIB 124 in which the mapping information about the devices located in the child piconet 100 and the P-MIB 126 in which the mapping information about the devices located in the parent piconet 200.

The C-PNC device 120 broadcasts the mapping information stored in the P-MIB 126 to the devices 140 and 160 located in the child piconet 100, and broadcasts the mapping information stored in the C-MIB 124 to the devices located in the parent piconet 200.

The device A 140 and the device B 160 which are located in the child piconet 100 generate mapping information for bridging the devices 220 and 240 located in the parent piconet 200 through the mapping information broadcast from the C-PNC device 120, and store and manage the generated mapping information in B-MIBs (Bridging Management Information Bases) 144 and 164.

The P-PNC device 220 and the device G 240 which are located in the parent piconet 200 generate mapping information for bridging the devices 140 and 160 located in the child piconet 100 through the mapping information broadcast from the C-PNC device 120, and store and manage the generated mapping information in B-MIBs 224 and 244. Accordingly, the respective devices 140, 160, 220 and 240 can transmit data to destinations devices located in different piconets with reference to the B-MIBs.

For example, in the case of transmitting data to the device G 240, the device A detects a MAC address of the device G 240, a device ID and a piconet with reference to the mapping information stored in the B-MIB 144, and inserts the detected information in a header of data. The data is transmitted to the C-PNC device 120 for an allocated time slot.

The C-PNC device 120 confirms the destination to which the data is to be transmitted by analyzing the header of the data transmitted from the device A 140. The C-PNC device 120 performs a bridging operation for transmitting the data transmitted from the device A 140 to the device G 240 by controlling the bridge 122. Accordingly, it can transmit the data transmitted from the device located in the child piconet 100 to the device located in the parent piconet 200 using the bridging function.

Accordingly, by making communications possible by applying a bridging protocol that supports communications among the devices located in the different piconets in the high-speed WPAN, the possible communication distance can be extended in the high-speed WPAN.

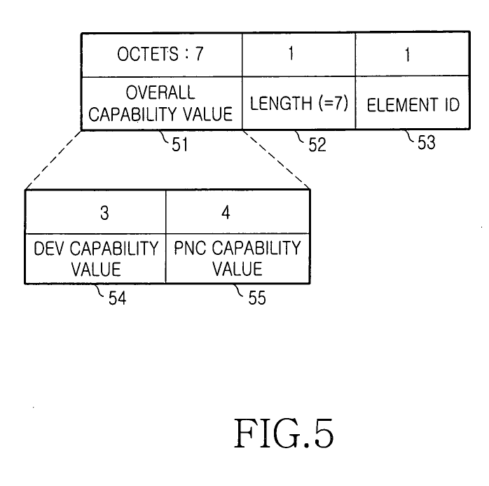

FIG. 5 is a view illustrating a conventional capability field structure of a device of a MAC frame according to the IEEE 802.15.

As shown in FIG. 5, the conventional capability field according to the IEEE 802.15.3 includes an overall capability field 51 composed of 7 bytes, a length field 52 composed of one byte, and an element ID field 53, composed of one byte, for discrimination among respective elements. Here, the detailed contents of the element ID field 53 are shown in Table 1 below.

| Element ID | |
|---|---|
| Hex value | Element |
| 0x00 | Channel time allocation |
| 0x01 | BSID |
| 0x02 | Parent piconet |
| 0x03 | DEV association |
| 0x04 | PNC shutdown |
| 0x05 | Piconet parameter change |
| 0x06 | Application specific |
| 0x07 | Pending channel time map |
| 0x08 | PNC handover |
| 0x09 | CTA status |
| 0x0A | Capability |
| 0x0B | Transmit power parameter |
| 0x0C | PS status |
| 0x0D | Continued wake beacon (CWB) |
| 0x0E | Overlapping PNID |
| 0x0F | Piconet services |
| 0x10-0x7F | Reserved |
| 0x80-0xFF | Vendor specific |

In Table 1, an element ID having a value of 0×00 includes channel time allocation information. An element ID having a value of 0×01 includes BSID (Beacon Source Identifier) information for identifying a source of a beacon. An element ID having a value of 0×02 includes parent piconet information for indicating a parent piconet. An element ID having a value of 0×03 indicates a device (DEV) association for indicating information of devices included in a piconet. An element ID having a value of 0×04 indicates a PNC shutdown for indicating a shutdown of a piconet coordinator (PNC). An element ID having a value of 0×05 indicates a piconet parameter change for indicating that the parameter of a piconet is changed. An element ID having a value of 0×06 indicates a specific application for permitting typical information for an extended operation in the standard. An element ID having a value of 0×07 indicates a PCTM (Pending Channel Time Map) for requesting a switchover to an active mode. An element ID having a value of 0×08 indicates a PNC handover in which a previous piconet coordinator (PNC) reports abandonment of the piconet control. An element ID having a value of 0×09 indicates a CTA (Channel Time Allocation) status whereby the PNC transfers a certain status of CTA to a specific device.

Also, an element ID having a value of 0×0A indicates a capability of the corresponding device. An element ID having a value of 0×0B indicates a transmission power parameter for transmitting a transmission power control capability of the corresponding device. An element ID having a value of 0×0C indicates a PS (Power Save) status of the corresponding device. An element ID having a value of 0×0D indicates a CWB (Continued Wake Beacon) for the corresponding device. An element ID having a value of 0×0E indicates an overlapping PNID for communications with another PNID sensed through the channel of the corresponding device or another channel. An element ID having a value of 0×0F indicates an overlapping PNID for providing information about application layer capabilities of the respective devices. An element ID having a value of 0×10 to 0×7F indicates a reserved area, and an element ID having a value of 0×80 to 0×FF indicates a specific vendor.

The overall capability field 51 includes a device (DEV) capability field 54, composed of three bytes, for indicating a device capability, and a PNC capability field 55, composed of four bytes, for indicating a capability for determining whether the specific device can be the PNC.

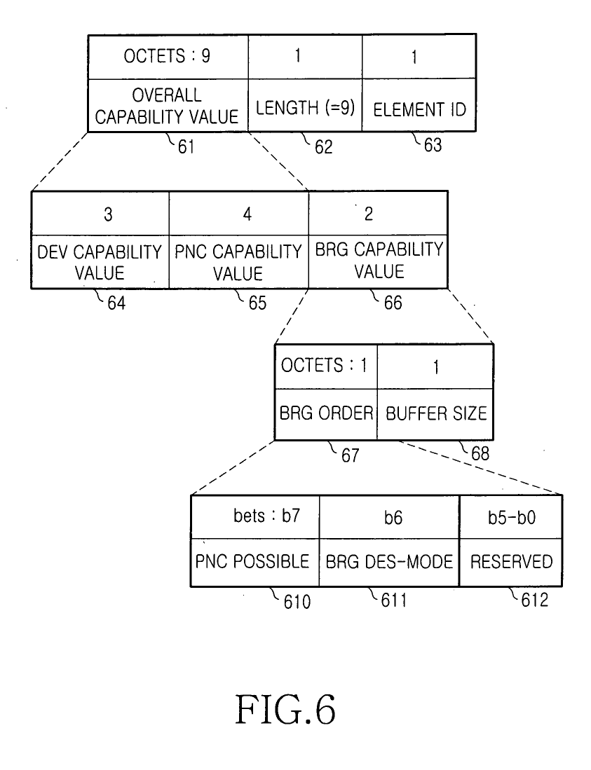

FIG. 6 is a view illustrating a capability field structure of a device of a MAC frame according to the present invention. As shown in FIG. 6, the capability field of a device of a MAC frame according to the present invention includes an overall capability field 61 composed of 9 bytes, a length field 62 composed of one byte, and an element identifier (ID) field 63, composed of one byte, for discrimination among respective elements.

The overall capability field 61 includes a device capability field 64, composed of three bytes, for indicating a device capability, a piconet coordinator (PNC) capability field 65, composed of four bytes, for indicating a capability for determining whether the specific device can be a PNC, and a bridge capability field 66, composed of two bytes, for indicating a capability for determining whether the specific device can operate as the bridge device. Here, the bridge capability field 66 includes a bridge order field 67, composed of one byte, for determining the order in which a device can be a bridge device, and a buffer size field 68, composed of one byte, for indicating a buffer size of the corresponding device. The bridge order field 67 includes a PNC possibility field 610 for indicating whether a device can be a PNC, a bridge Des-mode field 611 for indicating whether a device can be a bridge device, and a reserved field 612. The standard for selecting a bridge device is shown in Table 2 below.

| Order | Information | Note |
|---|---|---|
| 1 | BRG Des-mode bit in BRG | BRG Des-mode = 1 is preferred |
| | capabilities field | |
| 2 | Buffer Size (PHY dependent) | Higher value is preferred |
| 3 | PNC Des-mode bit in PNC | PNC Des-mode = 1 is preferred |
| | capabilities field | |
| 4 | SEC bit in PNC capabilities field | SEC = 1 is preferred |
| 5 | PSRC bit in PNC capabilities | PSRC = 1 is preferred |
| | field | |
| 6 | Max associated DEVs | Higher value is preferred |
| 7 | Transmitter power level | Higher value is preferred |
| | (PHY dependent) | |
| 8 | MAX PHY rate | Higher value is preferred |
| | (PHY dependent) | |

In selecting a bridge device, in the first order, a device whose bridge (BRG) Des-mode is “1” is selected as the bridge (BRG), and in the second order, a device having a large buffer size already physically determined is selected. In the third order, a device whose PNC Des-mode is “1” is selected, and in the fourth order, a device whose security bit is “1” is selected. In the fifth order, a device having a power source (PSRC) is selected, and in the sixth order, a device having a large number of associated devices is selected. In the seventh order, a device having a large output power is selected, and in the eighth order, a device having a high transmission speed is selected.

Following the above-described priority order, the probability that the C-PNC serves as the bridge device is heightened.

Here, even though it is proper for the C-PNC to serve as the bridge device, the reason why the first and second orders are determined, as described above, is to avoid the limitation that only the C-PNC may serve as the bridge device. That is, not even the C-PNC serves as the bridge device if it does not have the bridging function.

Also, in the present invention, by adding the bridge (BRG) capability field to the capability field of the device of the existing IEEE 802.15.3 MAC frame, a device which will perform the bridging function between the different piconets is selected in the order as defined in Table 2.

In the embodiment of the present invention, the priority order in Table 2 is determined so as to first consider the priority order that defines the piconet coordinator of the child piconet, and thus the piconet coordinator of the child piconet properly serves as the bridge device.

Meanwhile, if one device performs the bridging function in the high-speed WPAN according to the present invention, an information element should be added accordingly.

The newly added information element as above may be included in the “Reserved field (0×10−0×7F)” shown in Table 1, which includes a bridge group information element, a bridge shutdown information element and a bridge change information element.

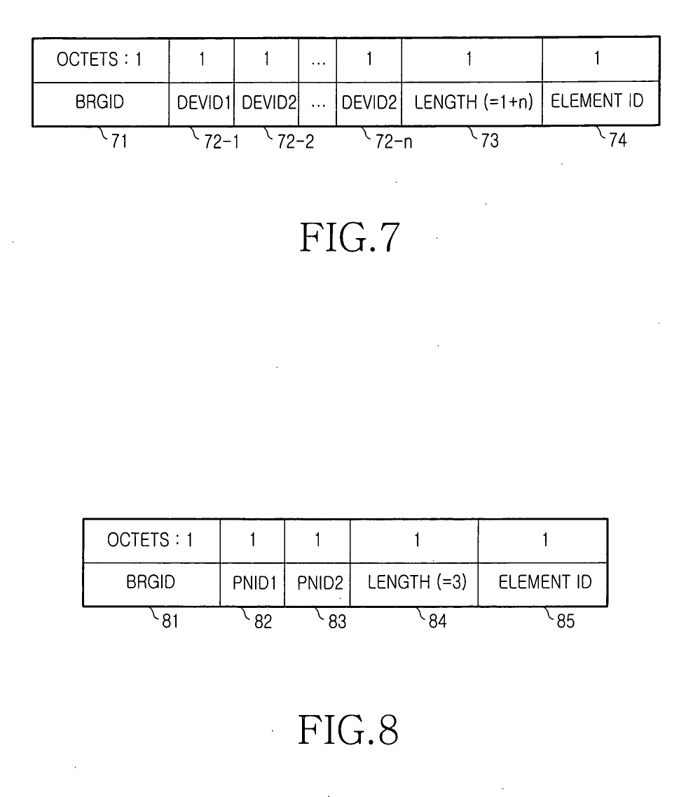

FIG. 7 is a view illustrating an example of a bridge group information element that is added to a MAC frame in which a bridge (BRG) capability field is included according to the present invention. The bridge group information element includes a bridge ID (BRGID) field 71, composed of one byte, for identifying the bridge device, device ID1 (DEVID1) field 72-1 to device IDn (DEVIDn) field 72-n, each composed of one byte, for indicating respective device IDs which are managed by the corresponding bridge device, a length field 73 composed of one byte, and an element ID field 74 composed of one byte. Here, the element ID included in the element ID field 74 includes a hex value of an information element in Table 1. The element ID newly added according to the present invention is allocated with a specified value of the reserved region of 0×10 to 0×7F.

FIG. 8 is a view illustrating another example of a bridge group information element that is added to a MAC frame in which a bridge (BRG) capability field is included according to the present invention.

In this aspect of the invention, the bridge group information element includes a bridge ID (BRGID) field 81, composed of one byte, for identifying the bridge device, PNID1 field 82-1 to PNID2 field 82-2, each composed of one byte, for indicating respective piconet IDs which are managed by the corresponding bridge device, a length field 83 composed of one byte, and an element ID field 84 composed of one byte. Here, the element ID included in the element ID field 84 includes a hex value (base 16) of an information element in Table 1. The element ID newly added according to the present invention is allocated with a specified value of the reserved region of 0×10 to 0×7F (base 16).

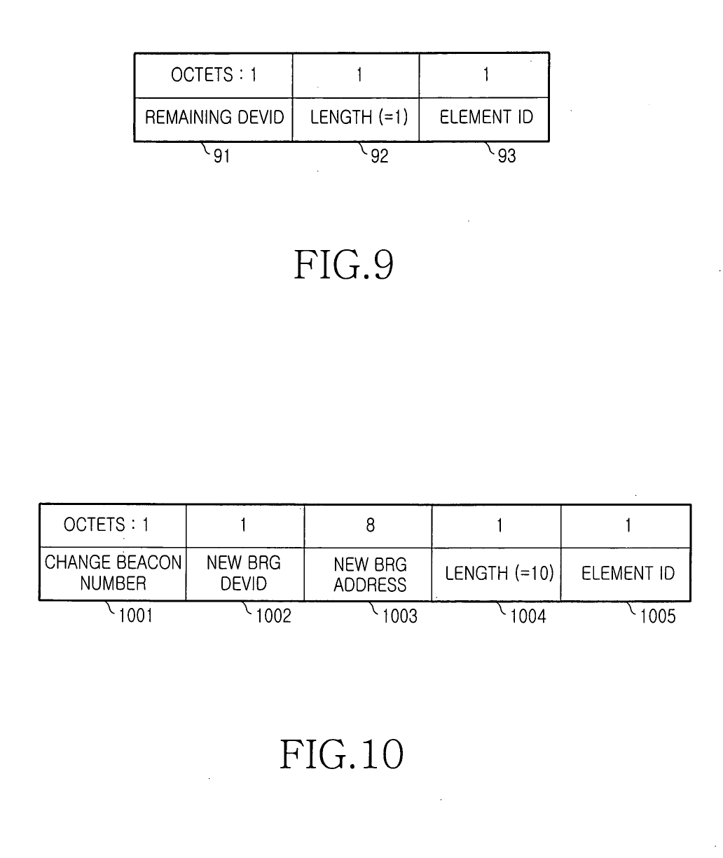

FIG. 9 is a view illustrating an example of a bridge shutdown information element that is added to a MAC frame in which a bridge (BRG) capability field is included according to the present invention. In this aspect of the invention, the bridge shutdown information element includes a device ID (DEVID) field 91, composed of one byte, for identifying the ID of the remaining device in order to select the bridge device, a length field 93 composed of one byte, and an element ID field 94 composed of one byte. Here, the element ID included in the element ID field 94 includes a hex (base 16) value of an information element in Table 1. The element ID newly added according to the present invention is allocated with a specified value of the reserved region of 0×10 to 0×7F.

The operation of each device according to the shutdown information element is shown in Table 3.

TABLE 3

| Element | | | DEV | PNC | DEV | DEV | PNC | PNC | BRG |
|---|---|---|---|---|---|---|---|---|---|
| ID Hex | | Present in | allowed to | allowed to | receives | receives | receives | allowed to | allowed to |
| value | Element | beacon | request? | request? | from BRG | from PNC | from BGR | send? | send? |
| 0x14 | BRG | Non- | Shall not | Shall not | Shall ignore | Shall ignore | Shall not | May not | May |
| | shutdown | beacon | request | request | | | ignore | allowed | allowed |
| | | IE | | | | | | | |

Table 3 illustrates an authority to request a bridge (BRG) shutdown and an order of processing the given authority. In Table 3, an element ID HEX value is identified as 0×14 of the reserved region in Table 1. However, other values may also be used as the element ID HEX value.

The element indicates a bridge (BRG) shutdown operation, and the bridge shutdown information is not presented in the beacon (Non-Beacon IE). The device or the PNC is not allowed to request, i.e., shall not request, the bridge shutdown. If the device receives the bridge shutdown information from the bridge or the PNC, it shall ignore this, but if the PNC receives the bridge shutdown information from the bridge, it shall not ignore this. The PNC may not be allowed to send the bridge shutdown information, and the bridge may be allowed to send the bridge shutdown information.

Specifically, devices which exist in the piconet may be a PNC (e.g., a piconet manager), a bridge (e.g., device having a bridging function) and a DEV (e.g., general device). If a device having a bridging function intends to discontinue the bridging function, only the present bridge may be allowed to send this information, but the general device or PNC may not be allowed to send the information. On the contrary, only the PNC (or CPNC) can receive, i.e., may not ignore, the bridge shutdown information in principle. Accordingly, the present bridge does not directly cause the next bridge candidate to operate, but informs the PNC that controls the piconet of the bridge shutdown information, so that the PNC recognizes that the next bridge candidate will be a new bridge device, and then informs other devices of this information. The existing bridge device informs other devices of which device is the next bridge candidate as shown as the information element of FIG. 9. This information element is not presented in the beacon.

That is, the information element of FIG. 9 is used for the present bridge device to one-sidedly inform the next bridge candidate of the bridge shutdown information when the present bridge device stops its bridging function. As shown in Table 3, the present bridge device sends other devices the corresponding information before it stops its bridging function, and only the PNC can refer to this information.

FIG. 10 is a view illustrating an example of a bridge device change information element that is added to a MAC frame in which a bridge (BRG) capability field is included according to the present invention. In this aspect of the invention, the bridge device change information element includes a change beacon number field 1001, composed of one byte, for indicating information about the changed beacon number, a new bridge device (BRG DEV) field 1002 for indicating the ID of the device which will be a new bridge device, a new bridge (BRG) address field 1003 for indicating the address of the device which will be a new bridge device, a length field 1004 composed of one byte, and an element ID field 1005 composed of one byte.

The bridge device change information element as illustrated in FIG. 10 is used for the PNC device that controls the beacon of the piconet to provide all the devices in the piconet with the information about the change of the bridge device. Here, the element ID included in the element ID field 1005 includes a hex value of the information element in Table 1. The element ID newly added according to the present invention is allocated with a specified value of the reserved region of 0×10 to 0×7F.

As described above, the present invention has the advantages in that it can select a device that can take charge of the bridging function among plural devices in the piconet by determining priority orders by defining a bridge capability value field for selecting the bridging function in the existing MAC frame structure.

Also, the present invention has the effect of providing an expected information element by defining a newly added bridge capability value field.

The method according to the present invention as described above may be implemented by a program, and stored in a recording medium (e.g., CD ROM, floppy disc, hard disc, optomagnetic disc, etc.) in the form readable through a computer.

While the invention has been shown and described with reference to certain embodiments thereof, it will be understood by those skilled in the art that various changes in form and details may be made therein without departing from the spirit and scope of the invention as defined by the appended claims.

1. A frame structure for selecting a bridge device in a high-speed wireless personal area network (WPAN) which includes a parent piconet designated in advance and having a plurality of devices, a newly designated child piconet using time slots allocated from the devices located in the parent piconet, and a bridge device which is located in the child piconet, broadcasts information about the devices of the parent piconet and information about the devices of the child piconet to the devices included in the high-speed WPAN, and operates to perform a data transfer between a first specific device included in the child piconet and a second specific device included in the parent piconet, the frame structure providing a media access control (MAC) frame which includes an overall capability field, composed of 9 bytes, for indicating an overall capability of a specific device, a length field, composed of one byte, for indicating a length of a frame, and an element identifier (ID) field for identifying respective elements;
wherein the overall capability field includes a device capability field for indicating a capability of the specific device, a piconet coordinator capability field for indicating a capability for determining whether the specific device can be a piconet coordinator (PNC), and a bridge capability field for indicating a capability for determining whether the specific device can be the bridge device.

2. The frame structure as claimed in claim 1, wherein the bridge capability field comprises:
a bridge order field, composed of one byte, for determining the order in which the device can be the bridge device; and
a buffer size field, composed of one byte, for indicating a physical buffer size of the specific device.

3. The frame structure as claimed in claim 2, wherein the bridge order field comprises:
a PNC possibility field for indicating whether the specific device can operate as the PNC;
a bridge Des-mode field for indicating whether the specific device can be the bridge device; and
a reserved field.

4. The frame structure as claimed in claim 2, wherein the element discriminated by the element ID field comprises:
a bridge group information element which includes a bridge ID for identifying the specific device that operates as the bridge device; and
a plurality of device ID fields that indicate the devices managed by the specific device;
wherein a specific element ID is given to the bridge group information element.

5. The frame structure as claimed in claim 2, wherein the element discriminated by the element ID field comprises:
a bridge group information element which includes a bridge ID for identifying the specific device that operates as the bridge device; and
a plurality of piconet ID fields that indicate the piconets managed by the specific device;
wherein a specific element ID is given to the bridge group information element.

6. The frame structure as claimed in claim 2, wherein the element discriminated by the element ID field comprises a bridge shutdown element which includes a device ID field provided for identifying IDs of the remaining devices in order to newly select the bridge device, and makes the presently operating bridge device transfer information of the bridge device to the piconet coordinator before termination of its bridging function;
wherein a specific element ID is given to the bridge shutdown element.

7. The frame structure as claimed in claim 6, wherein only the device that is presently performing the bridging function can transmit the bridge shutdown element, and only the piconet coordinator can receive the bridge shutdown element;
wherein the piconet coordinator broadcasts the change of the bridge device according to the bridge shutdown element to other devices.

8. The frame structure as claimed in claim 6, wherein the bridge shutdown element is not transferred by a beacon.

9. The frame structure as claimed in claim 2 wherein the bridge device change information element comprises:
a change beacon number field for indicating information about the changed beacon number;
a new bridge device ID field for indicating an ID of the device that will newly perform the bridge function; and
a new bridge device address field for indicating an address of the device that will perform the bridge function, and makes the piconet coordinator transfer information about the change of the bridge device to all the devices in the piconet;
wherein a specific element ID is given to the bridge device change information element.

10. A method for selecting a bridge device in a high-speed wireless personal area network (WPAN) which includes a parent piconet designated in advance and having a plurality of devices, a newly designated child piconet using time slots allocated from the devices located in the parent piconet, and a bridge device which is located in the child piconet, that broadcasts information about the devices of the parent piconet and information about the devices of the child piconet to the devices included in the high-speed WPAN, and operates to perform a data transfer between a first specific device included in the child piconet and a second specific device included in the parent piconet, the method comprising the steps of:
1. detecting devices that can operate as the bridge device;
2. selecting a device as the bridge device while comparing sizes of buffers of the detected devices, which have physically been determined, if plural devices which can operate as the bridge device are detected;
3. selecting the device having the largest buffer size as a result of comparison at the second step as the bridge device, and if there are plural devices having the same largest buffer size, selecting a piconet coordinator among the devices having the same largest buffer size as the bridge device;
4. selecting the device whose security bit is activated as the bridge device if there is no piconet coordinator among the devices having the same largest buffer size;
5. a selecting the device having a power source as the bridge device if there are plural devices whose security bits are activated, or if there is no device whose security bit is activated at the fourth step;
6. selecting the device having a large number of associated devices as the bridge device if there are plural devices having the power source, or if there is no device having the power source at the fifth step;
7. selecting the device having a large output power if there are plural devices having a large number of associated devices at the sixth step; and
8. selecting the device having a high transmission speed as the bridge device if there are plural devices having the large output power, or if there is no device having the large output power at the seventh step.

11. A system for selecting a bridge device in a high-speed wireless personal area network (WPAN) comprising a parent piconet having a plurality of devices, and a designated child piconet wherein time slots allocated are used for communication among devices located in the parent piconet, that operates to perform a data transfer between a one device included in the child piconet and a another device included in the parent piconet, the system comprising:
a memory;
a processor in communication with the memory, for executing code for:
determining at least one device within the child piconet that can operate as the bridge device;
selecting a device as the bridge device based on the criteria:
selecting the device having the largest buffer size;
selecting a piconet coordinator among the devices having the same largest buffer size;
selecting the device whose security bit is activated if there is no piconet coordinator among the devices having the same largest buffer size;
selecting the device having a power source if there are a plurality of devices whose security bits are activated, or if there is no device whose security bit is activated;
selecting the device having a large number of associated devices as the bridge device if there are a plurality of devices having the power source, or if there is no device having the power source;
selecting the device having a large output power if there are a plurality of devices having a large number of associated devices; and
selecting the device having a high transmission speed as the bridge device if there are a plurality of devices having the large output power, or if there is no device having the large output power.

12. The system as recited in claim 11, further comprising:
an input/output device in communication with the memory and the processor.

13. The system as recited in claim 11, wherein the code is stored in the memory.

14. The systems as recited in claim 11, wherein the memory is selected from the group consisting of: magnetic, optical, and semiconductor.

15. In a wireless communication network containing devices organized in parent networks and sub-networks, wherein a device in the parent network operates additionally a controlling device for a corresponding sub-network, a method for determining a bridging device from devices in the sub-network for allowing direct communication between devices in the parent network and the sub-network, the method comprising the steps of:
determining at least one device within the sub-network that can operate as the bridge device;
selecting a device operable as the bridge device based on the criteria selected from the group consisting of: buffer size, operation as a sub-network coordinator, activated security bit, power source, and number of associated devices, output power; and transmission speed.

16. The method as recited in claim 15, wherein the device having the largest buffer size among the determined devices.

17. The method as recited in claim 16, wherein the device is operable as a sub- network coordinator when a plurality of devices have comparable buffer size.

18. The method as recited in claim 17, wherein a security bit is activated when a plurality of devices are determined to be operable as a sub-network coordinator.

19. The method as recited in claim 18, wherein a power source is indicated when a plurality of devices have a security bit activated.

20. The method as recited in claim 19, wherein the number of associated devices is the large when a plurality of devices have a power source.

21. The method as recited in claim 20, wherein the output power is the largest when a plurality of devices have substantially equal number of associated devices.

22. The method as recited in claim 21, wherein the transmission speed is the highest when a plurality of devices have substantially equal output powers.
